(19) United States
(12) Patent Application Publication
(10) Pub. No.: US 2002/0158358 A1
(43) Pub. Date: Oct. 31, 2002

(54) Footwear manufacturing system

(76) Inventor: Brian J. Franzene, Lake Geneva, WI (US)

Correspondence Address: Michael S. Neustel, 2534 South University Drive, Suite No. 4, Fargo, ND, 58103, US

(21) Appl. No.: 09/844,860

(22) Filed: Apr. 27, 2001

(51) Int. Cl. B29D 31/515

(52) U.S. Cl. 264/40.1; 425/2; 249/155; 264/223

(57) ABSTRACT

A footwear manufacturing system for providing an efficient and economical system for manufacturing affordable custom footwear. The footwear manufacturing system includes measuring a foot, creating a foot profile, transmitting the foot profile to a manufacturing station, utilizing the foot profile to generate a positive impression within a mold, and injecting the mold with a liquid forming about the positive impression and hardening. Various foot measuring techniques may be utilized to create the foot profile. The manufacturing station preferably utilizes a mold utilizing a plurality of adjustable pins that manipulate a membrane within the mold to create the positive impression.

### BACKGROUND OF THE INVENTION

### CROSS-REFERENCE TO RELATED DISCLOSURE DOCUMENT

This application incorporates subject matter contained within Disclosure Document No. 486,751 received within the United States Patent and Trademark Office on Jan. 3, 2001. Disclosure Document No. 486,751 is incorporated by reference into this patent application.

### FIELD OF THE INVENTION

The present invention relates generally to the manufacture of custom footwear and more specifically it relates to a footwear manufacturing system for providing an efficient and economical system for manufacturing affordable custom footwear.

With the proliferation of connections to the Internet by a rapidly growing number of individuals, the viability of the Internet as a widely accepted medium of communication and business activity has increased correspondingly. The Internet is comprised of a global computer network allowing various types of data to be transmitted including but not limited to video, audio and graphical images. The type of connection the individual has to the Internet determines the overall quality and speed of their Internet experience.

### DESCRIPTION OF THE PRIOR ART

Custom shoe manufacturing processes have been in use for years. The most common method of manufacturing custom shoes is by the usage of a “kit” containing a foam mold that the user steps into with their feet that creates a positive impression within the foam mold. The user then mails the box containing the foam mold to the manufacturer who then manufactures footwear for the consumer based upon the impression within the foam mold.

The main problem with conventional custom footwear manufacturing processes is that it requires a significant amount of time to manufacture. A further problem with conventional custom footwear manufacturing processes is that the company must retain the bulky molds in storage for the user to “reorder” additional footwear. Another problem with conventional custom footwear manufacturing processes is that the consumer is typically unable to reorder addition footwear based upon their previous measurements. A further problem with conventional custom footwear manufacturing processes is that the positive core of the mold may only be utilized once. In addition, a core casting may shrink by approximately 2.5% between the time of casting to the time the manufacturer receives the positive core.

Examples of patented footwear manufacturing system which are illustrative of such prior art include U.S. Pat. Nos. 5,206,804; 5,361,133; 5,457,325; 3,696,456; and 5,753,931.

While these Internet based systems may be suitable for the particular purpose to which they address, they are not as suitable for providing an efficient and economical system for manufacturing affordable custom footwear. Conventional manufacturing processes are expensive and require significant time to manufacture the custom footwear.

In these respects, the footwear manufacturing system according to the present invention substantially departs from the conventional concepts and designs of the prior art, and in so doing provides a system primarily developed for the purpose of providing an efficient and economical system for manufacturing affordable custom footwear.

### SUMMARY OF THE INVENTION

In view of the foregoing disadvantages inherent in the known types of custom footwear manufacturing processes now present in the prior art, the present invention provides a new footwear manufacturing system wherein the same can be utilized for providing an efficient and economical system for manufacturing affordable custom footwear.

The general purpose of the present invention, which will be described subsequently in greater detail, is to provide a new footwear manufacturing system that has many of the advantages of the custom footwear manufacturing processes mentioned heretofore and many novel features that result in a new footwear manufacturing system which is not anticipated, rendered obvious, suggested, or even implied by any of the prior art custom footwear manufacturing processes, either alone or in any combination thereof.

To attain this, the present invention generally comprises measuring a foot, creating a foot profile, transmitting the foot profile to a manufacturing station, utilizing the foot profile to generate a positive impression within a mold, and injecting the mold with a liquid forming about the positive impression and hardening. Various foot measuring techniques may be utilized to create the foot profile. The manufacturing station preferably utilizes a mold utilizing a plurality of adjustable pins that manipulate a membrane within the mold to create the positive impression.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a footwear manufacturing system that will overcome the shortcomings of the prior art systems.

A second object is to provide a footwear manufacturing system for providing an efficient and economical system for manufacturing affordable custom footwear.

Another object is to provide a footwear manufacturing system that provides a consumer with custom manufactured footwear at an affordable cost.

An additional object is to provide a footwear manufacturing system that assists shoe sale businesses by increasing consumer satisfaction and lowering inventory costs.

A further object is to provide a footwear manufacturing system that quickly and efficiently manufactures custom footwear after determining the measurements of a foot.

Another object is to provide a footwear manufacturing system that does not utilize a positive core mold.

A further object is to provide a footwear manufacturing system that provides accurate custom manufactured insoles for footwear.

Another object is to provide a footwear manufacturing system that is capable of manufacturing various types of footwear such as but not limited to shoes, boots, sandals and the like.

A further object is to provide a footwear manufacturing system that reduces foot pain and related physical ailments.

Another object is to provide a footwear manufacturing system that eliminates the normal “break-in” period for footwear.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a foot positioned within the scanner for creating the foot profile.

FIG. 2 is a front view of a display screen showing the foot profile after being measured by the scanner.

FIG. 3 is an exemplary computer system that may be utilized with the present invention.

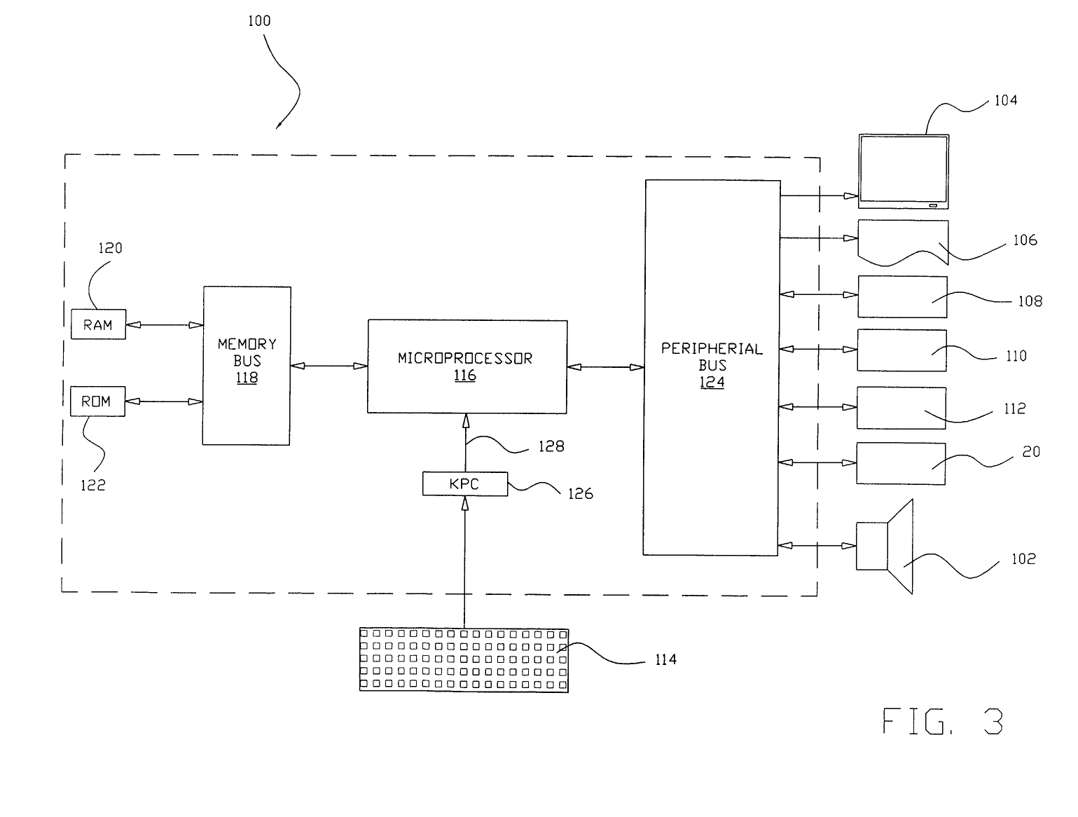

FIG. 4 is a block diagram illustrating the communications between the computer system and the manufacturing station.

FIG. 5 is a flowchart illustrating the overall function and operation of the present invention.

FIG. 6 is a front cutaway view of the mold showing the plurality of pins within that manipulate the membrane into a positive impression of the foot thereby creating a cavity within for receiving resin.

FIG. 7 is a front cutaway view of the mold showing the plurality of pins within that manipulate the membrane into a positive impression of the foot with the cavity filled with resin.

FIG. 8 is a top view of the upper portion and the lower portion of the mold.

FIG. 9 is a top view of a custom insole removed from the mold.

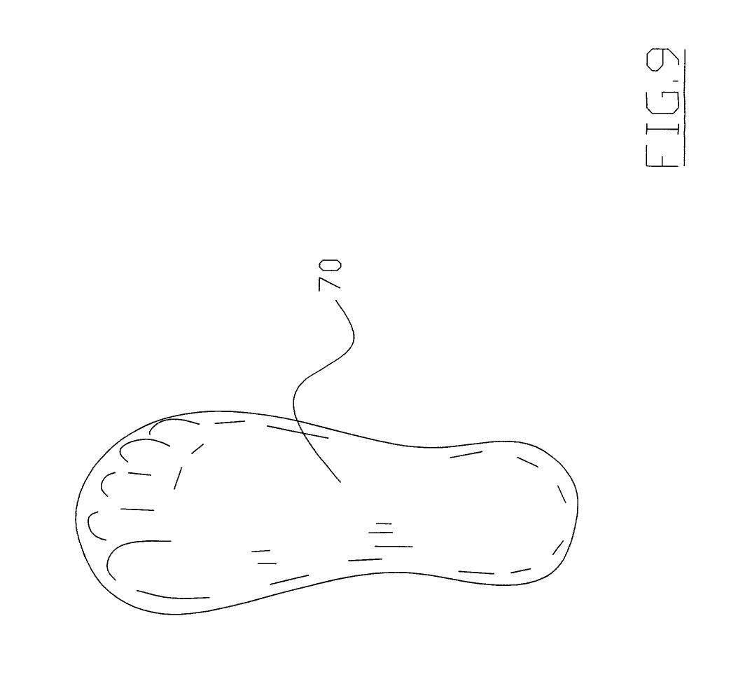

FIG. 10 is an upper perspective view of the custom insole.

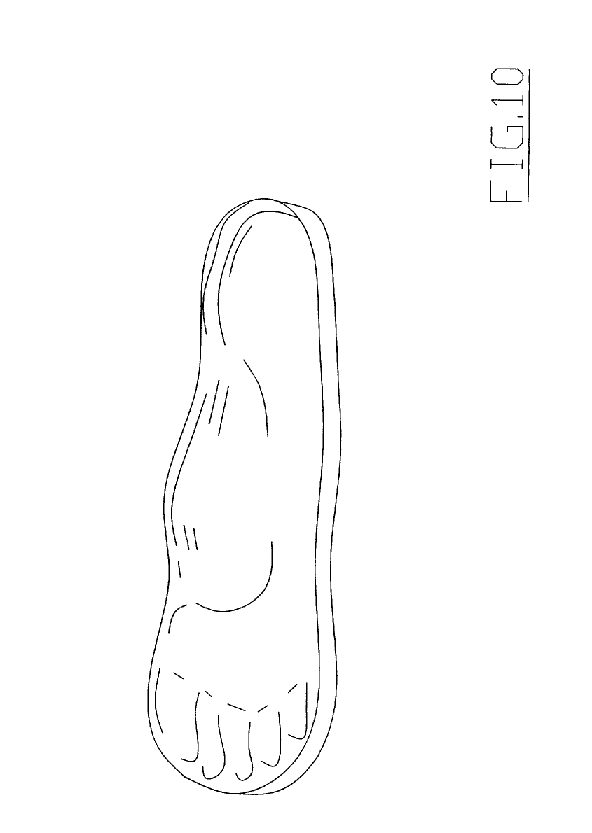

FIG. 11 is a cross sectional view taken along line 11-11 of FIG. 7.

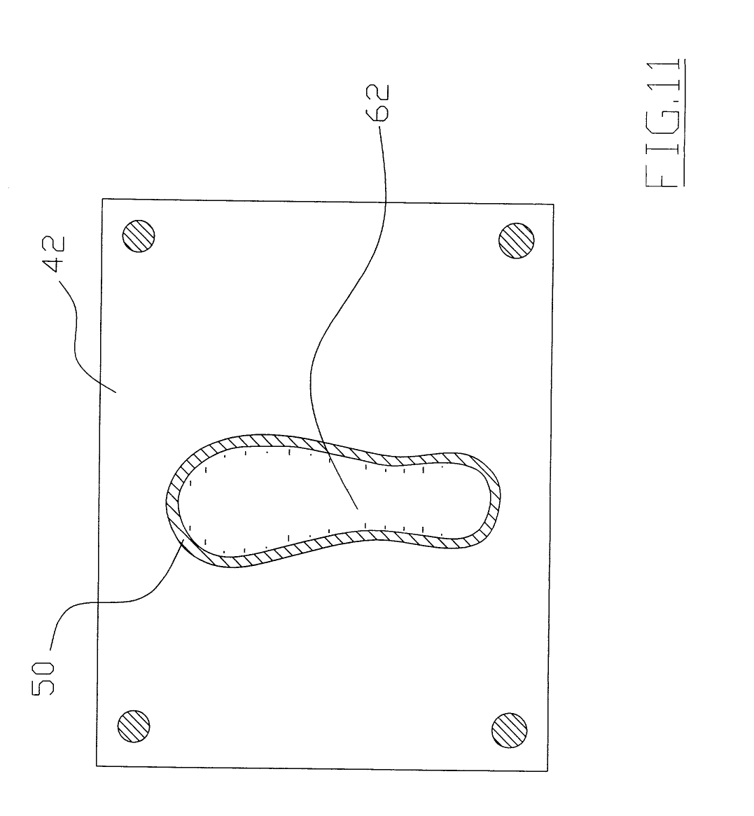

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

A. Overview

The present invention is mainly comprised of measuring a foot, creating a foot profile, transmitting the foot profile to a manufacturing station 30, utilizing the foot profile to generate a positive impression within a mold 40, and injecting the mold with a liquid resin forming about the positive impression and hardening. Various foot measuring techniques may be utilized to create the foot profile. The manufacturing station 30 preferably utilizes a mold 40 utilizing a plurality of adjustable pins 62 that manipulate a membrane 50 within the mold 40 to create the positive impression.

B. Exemplary Computer System

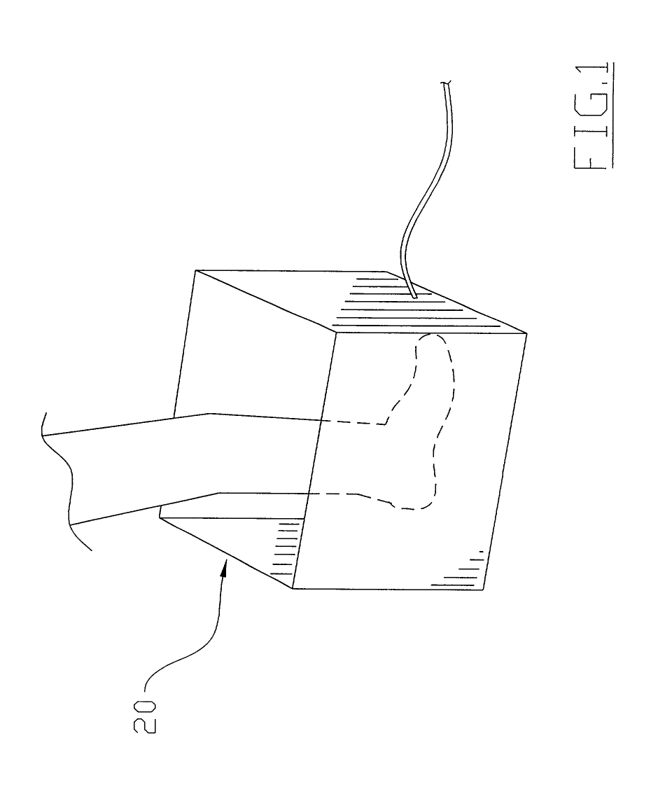

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. Other types of user input devices can also be utilized in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

C. Communications System

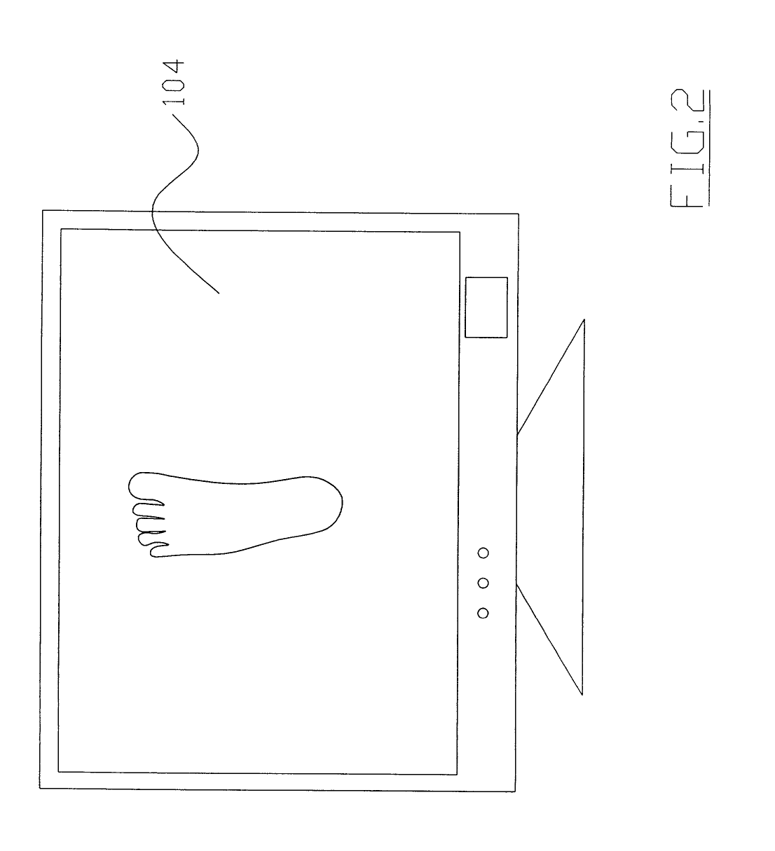

As shown in FIG. 2, the Internet 12 is comprised of a “global computer network”. A plurality of computer systems 100 around the world are in communication with one another via this global computer network. The present invention preferably utilizes the Internet 12 to transmit foot profile data to the manufacturing station 30, however it can be appreciated that as future technologies are created that various aspects of the invention may be practiced with these improved technologies.

D. Scanner

The present invention initially utilizes a scanner 20 or similar device to “measure” the foot. Measurements include the size, shape, contours and other measurements important to creating a custom insole 70 that will conform to the foot. The scanner 20 is capable of measuring the lower portion of the foot to create a foot profile converted to a digital format.

The scanner 20 may be comprised of any technology capable measuring three-dimensional objects and surfaces such as but not limited to pressure and optical technology. In addition, the following United States patents are considered relevant to the measuring of the foot to create a digital foot profile of the present invention and are incorporated herein by reference: U.S. Pat. Nos. 5,206,804; 5,361,133; 5,457,325; 3,696,456; and 5,753,931. The aforementioned patents, some of which are mentioned elsewhere in this disclosure, and which form a part of this disclosure, may be applied in known manner by those skilled in the art in order to practice various embodiments of the present invention. It can be appreciated that various other well-known technologies may be utilized to construct and operate the scanner 20 for creating three-dimensional foot profiles in a digital format.

E. Manufacturing Station

Once the foot profile data is generated by the scanner 20, the foot profile data is transferred to the manufacturing station 30 via the Internet 12. Other well-known means may be utilized to transfer the foot profile to the manufacturing station 30 as can be appreciated.

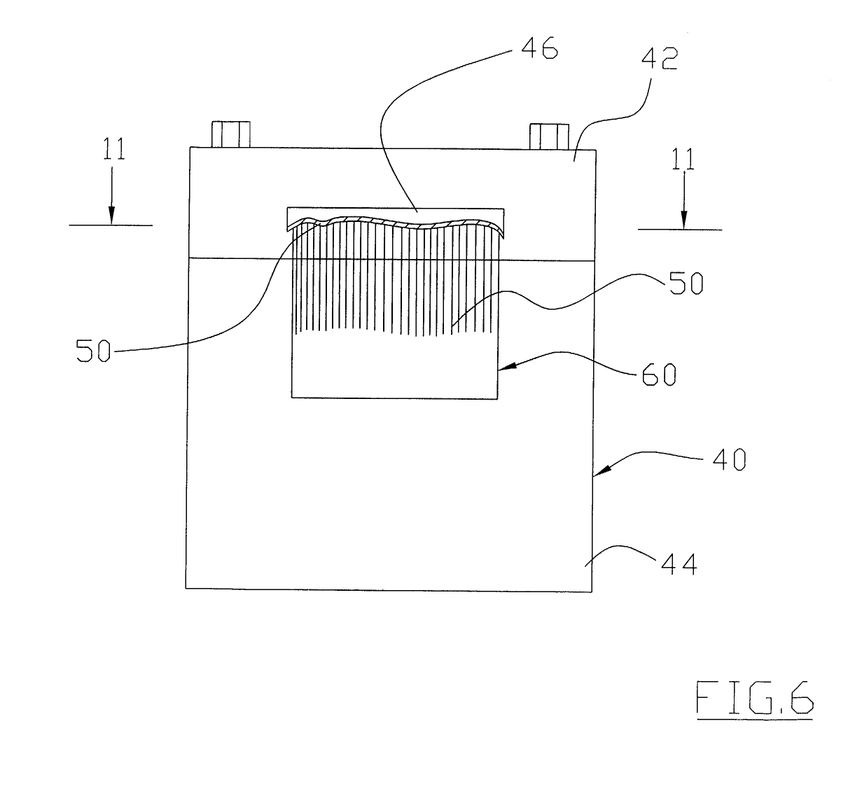

The manufacturing station 30 includes a computer system 100 that receives the foot profile data. The computer system 100 is in communication with a forming unit 60 that contains a plurality of vertically or horizontally adjustable pins 62 as shown in FIG. 6 of the drawings. The computer system 100 instructs the forming unit 60 as to what the positive imprint should be wherein the plurality of pins are manipulated vertically or horizontally to create a three-dimensional positive imprint of the lower portion of the foot.

The forming unit 60 may be comprised of any well-known structure capable of manipulating a plurality of pins 62 into a three-dimensional shape. In addition, the following United States patents are considered relevant to the manipulation of a plurality of pins within the present invention and are incorporated herein by reference: U.S. Pat. Nos. 4,191,945 and 5,165,897. The aforementioned patents, some of which are mentioned elsewhere in this disclosure, and which form a part of this disclosure, may be applied in known manner by those skilled in the art in order to practice various embodiments of the present invention.

To prevent the liquid resin from seeping into the plurality of pins 62, a resilient membrane 50 is positioned about the plurality of pins 62 that conforms to the three-dimensional positive imprint as defined by the foot profile data received from the scanner 20. The membrane 50 may be constructed of any resilient material such as but not limited to plastic or rubber.

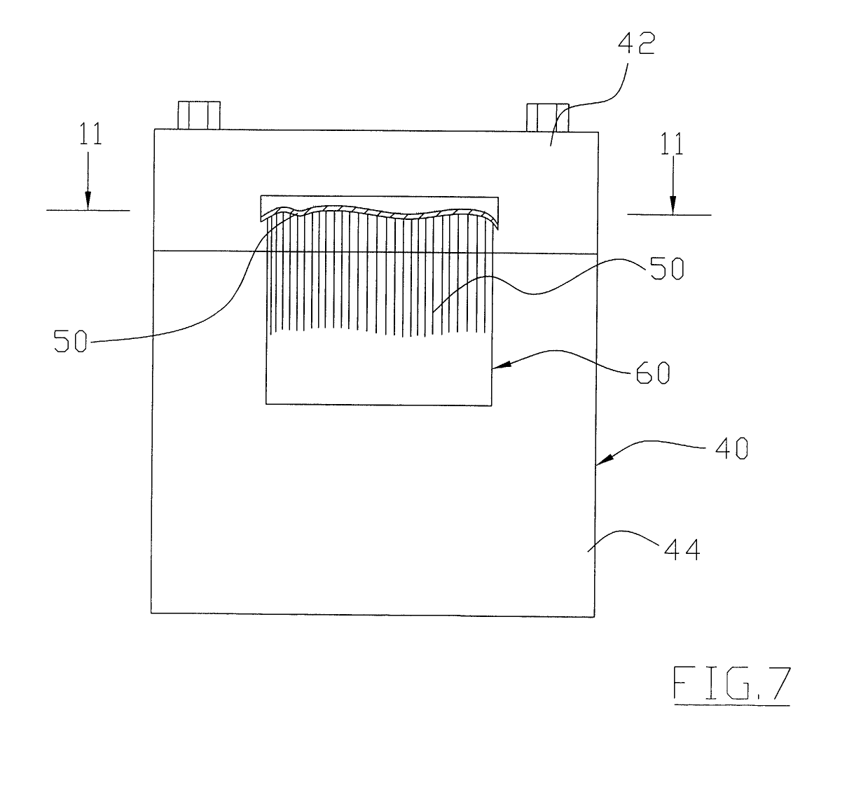

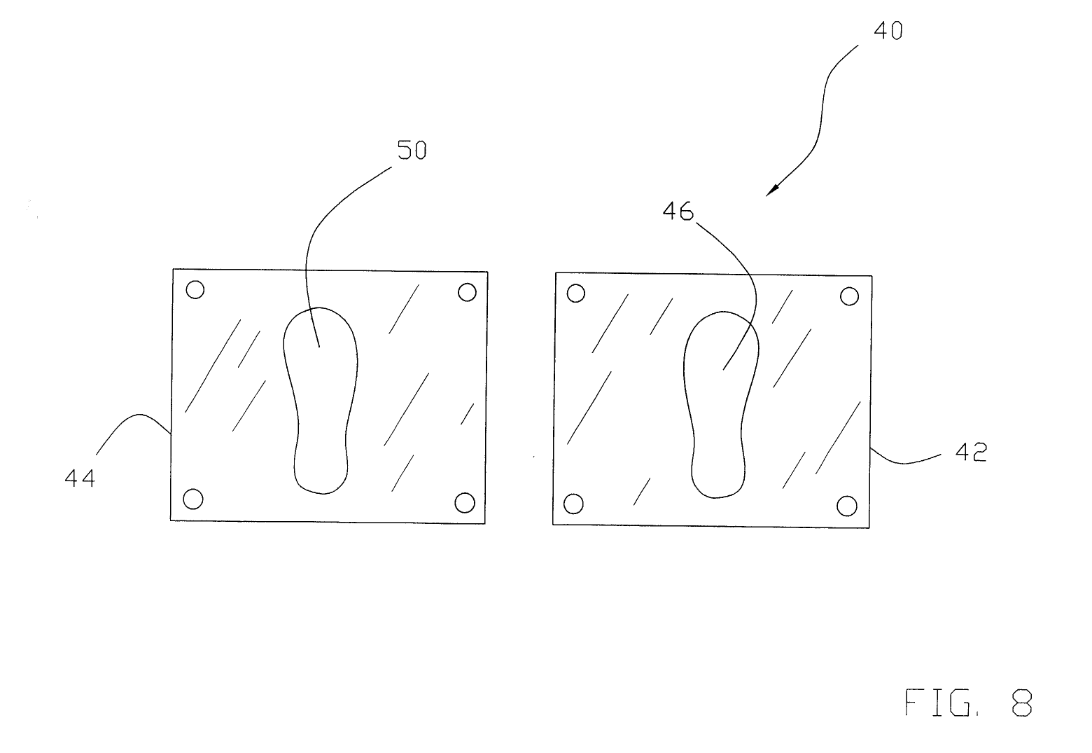

The forming unit is positioned within the lower portion 44 of the mold 40. An upper portion 42 of the mold 40 is removably attachable to the lower portion 44 for defining a cavity 46 between the membrane 50 and the upper portion 42 as shown in FIG. 6 of the drawings. FIG. 8 illustrates the inner surfaces of both the lower portion 44 and the upper portion 42 of the mold 40. The cavity 46 receives a volume of liquid resin utilized to create the insole as shown in FIG. 7 of the drawings. The liquid resin may be comprised of any well-known resin that is able to create an insole 70 for footwear.

F. Operation

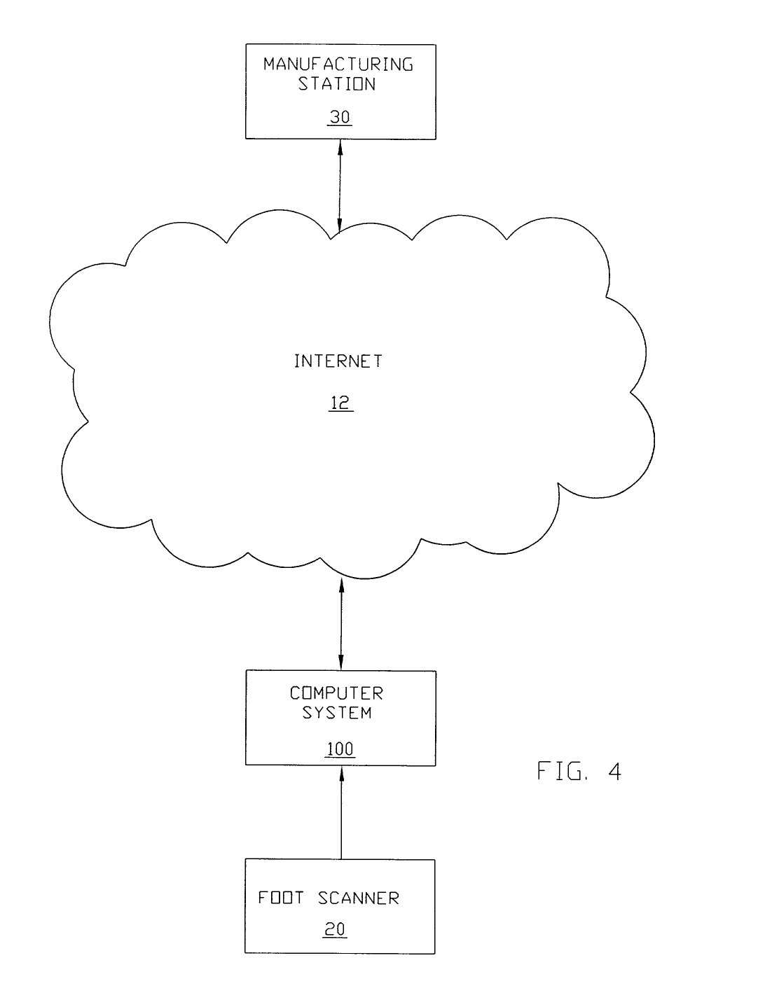

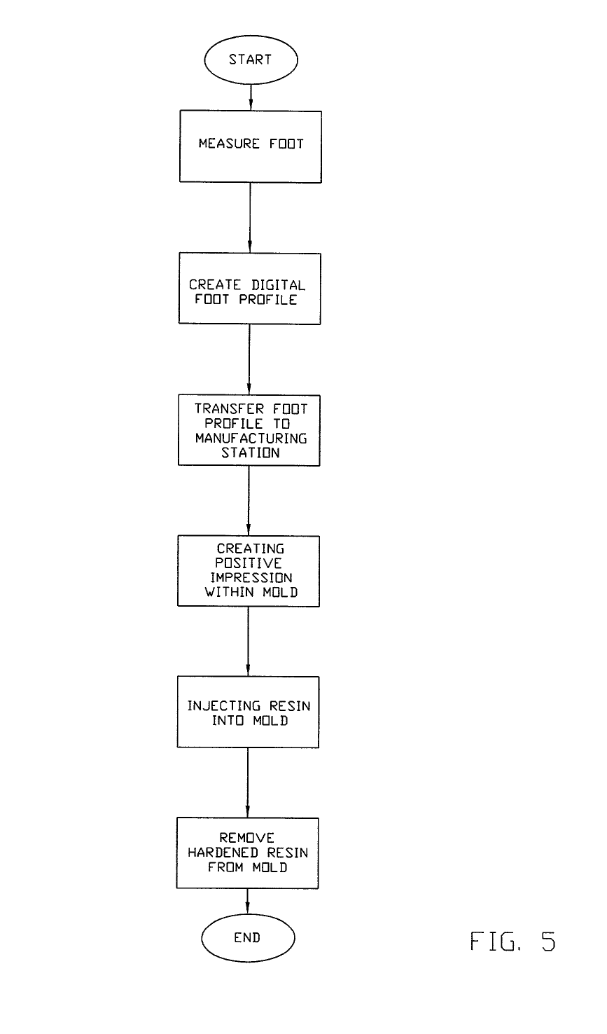

In use, a customer positions their foot within the scanner 20 as illustrated in FIG. 1 of the drawings. The computer system 100 connected to the scanner 20 generates a foot profile based upon the readings of the scanner 20. The computer system 100 then transfers the foot profile data via the Internet to the manufacturing station 30 as shown in FIGS. 4 and 5 of the drawings. Once the foot profile data has been transferred to the manufacturing station 30, another computer system 100 at the manufacturing station 30 communicates with the forming unit 60 to manipulate the plurality of pins 62 in a desired vertical or horizontal position to recreate a positive imprint of the foot as determined by the foot profile data. As the pins 62 are manipulated into the desired position within the forming unit 60 they correspondingly manipulate the membrane 50 outwardly in specific locations corresponding to extended lower portions of the foot such as the heel. Once the membrane 50 is fully manipulated to reflect the positive imprint of the foot, the liquid resin is injected into the cavity 46 defined between the upper portion 42 and the lower portion 44 of the mold 40. The resin is allowed to harden and then the upper portion 42 is separated from the lower portion 44 of the mold 40 thereby allowing the custom insole 70 to be removed. The custom insole 70 is shaped to comfortably receive the foot of the user without requiring a breaking-in period. The custom insole 70 may be utilized directly as a sandal, shoe sole, or positioned within a shoe structure.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A footwear manufacturing system, comprising:
a scanner for taking measurements of a foot;
a means for creating a foot profile based upon said measurements;
a manufacturing station for receiving said foot profile and creating an insole based upon said foot profile.

2. The footwear manufacturing system of claim 1, wherein said manufacturing station is comprised of:
a mold; and
a forming unit within said mold, wherein said forming unit creates a positive impression of said foot based upon said foot profile for creating an upper portion of said insole.

3. The footwear manufacturing system of claim 2, wherein said forming unit includes a plurality of pins that are adjustable to reflect said positive impression of said foot.

4. The footwear manufacturing system of claim 3, wherein said forming unit includes a membrane positioned upon said plurality of pins.

5. The footwear manufacturing system of claim 4, wherein said membrane is comprised of a resilient material.

6. The footwear manufacturing system of claim 5, wherein said mold is comprised of a first portion containing said forming unit and a second portion containing a cavity for defining a lower portion of said insole.

7. The footwear manufacturing system of claim 6, wherein said means for creating a foot profile is comprised of a computer system.

8. The footwear manufacturing system of claim 7, wherein said computer system transmits said foot profile to said manufacturing station via a global computer network.

9. A method of producing a custom insole for footwear, comprising the steps of:
(a) taking measurements a foot;
(b) creating a foot profile based upon said measurements;
(c) transferring said foot profile to a manufacturing station; and
(d) producing said custom insole from said foot profile.

10. The method of producing said custom insole for footwear of claim 9, wherein said step (d) producing said custom insole is comprised of the following steps:
(i) generating a positive impression within a mold based upon said foot profile;
(ii) injecting a liquid resin into said mold formed upon said positive impression; and
(iii) removing said custom insole after said liquid resin has hardened.

11. The method of producing said custom insole for footwear of claim 10, wherein said step (i) generating a positive impression comprises the steps of:
(A) manipulating a plurality of pins beneath a membrane within a forming unit of said mold to reflect said positive impression; and
(B) resetting said plurality of pins after said step (iii) is completed.

12. The method of producing said custom insole for footwear of claim 11, wherein step (c) transferring said foot profile utilizes a global computer network.
